(19) United States
(12) Patent Application Publication
(10) Pub. No.: US 2008/0099626 A1
(43) Pub. Date: May 1, 2008

(54) Reconfigurable reaction wheel for spacecraft

(75) Inventor: William E. Bialke, Trumansburg, NY (US)

Correspondence Address: EDWARDS ANGELL PALMER & DODGE LLP;(ALL GOODRICH ENTITIES), P.O. BOX 55874, BOSTON, MA, 02205, US

(73) Assignee: Goodrich Corporation

(21) Appl. No.: 11/588,801

(22) Filed: Oct. 27, 2006

(51) Int. Cl. B64G 1/28

(52) U.S. Cl. 244/165

(57) ABSTRACT

The invention provides a reconfigurable reaction wheel for a spacecraft, a spacecraft, and a method of using the reconfigurable reaction wheel to control the movement of a spacecraft. The reaction wheel includes a reaction wheel housing, a flywheel rotatably disposed in the housing and an electric motor operably coupled to the flywheel. The electric motor includes a plurality of electrical windings. The motor is adapted and configured to operate in a first selectable operating state wherein the windings are arranged in a first electrical configuration, and a second selectable operating state wherein the windings are arranged in a second electrical configuration different from the first electrical configuration.

### BACKGROUND OF THE INVENTION

1. Field of the Invention

The present invention relates to a device for stabilizing spacecraft. Particularly, the present invention is directed to a reaction wheel that can operate in a plurality of selectable operating states.

2. Description of Related Art

Spacecraft mission objectives are generally bounded by the capabilities of existing technologies or incremental next-generation technological advances that can be achieved with reasonable development costs. As the state-of-the-art in a particular technology advances, mission objectives and capabilities can be re-examined and possibly redefined to take advantage of those advances.

A reaction wheel is a type of flywheel used primarily by spacecraft to change their angular momentum without using fuel for rockets or other reaction devices. They increase the pointing precision and reliability of a spacecraft, and may also reduce the mass fraction needed for fuel. Spin-up and braking are generally controlled electronically by computer controls. The strength of the materials of a momentum wheel, among other things, establishes a speed at which the wheel would come apart, and therefore how much angular momentum it can store. Since the momentum wheel is a small fraction of the spacecraft's total mass, easily-measurable changes in its speed provide very precise changes in angle. Reaction wheels therefore permit very precise changes in a spacecraft's attitude. For this reason, reaction wheels are an attractive option for use in aiming spacecraft with cameras or telescopes.

With the ever-increasing cost of spacecraft development, launch and mission operations, it is more common to have multiple payloads on one spacecraft bus. This presents a difficult challenge for a systems engineer designing a spacecraft since each payload generally has a different set of operating requirements. Operating parameters relating to reaction wheels include, for example, torque, power, momentum storage and management, and disturbances induced on the payload by a spinning reaction wheel. Traditionally, the systems engineer gathers together the operating requirements for each payload instrument or experiment on the spacecraft and creates a superset of requirements that encompasses all possible operating conditions. Then, these system level requirements are analyzed and flowed down via hardware specifications to the individual bus sensors and actuators such as the reaction wheel assemblies used on the bus.

This approach, by nature, forces the mission planners to collect together on one spacecraft a few payloads with similar operating requirements to avoid defining a mission with such widely varying requirements that it cannot be achieved using a single set of reaction wheel assemblies. For example, certain mission conditions and payloads may have diverging requirements (such as differing torque or momentum requirements) that would require multiple reaction wheels for providing torque about each axis of the spacecraft. Because of weight considerations, it is rarely, if ever, practical to employ such an arrangement of multiple reaction wheels to provide torque about each direction. As such, the mission planner is limited in the objectives that may be achieved on a given mission.

As can be seen, there still remains a continued need in the art for improvements in spacecraft components to make it easier and less expensive to construct spacecraft. Moreover, there remains a continuing need in the art for technologies that provide new technology options to mission planners. The present invention provides a solution for these and other problems, as described herein.

### SUMMARY OF THE INVENTION

The purpose and advantages of the present invention will be set forth in and become apparent from the description that follows. Additional advantages of the invention will be realized and attained by the methods and systems particularly pointed out in the written description and claims hereof, as well as from the appended drawings.

To achieve these and other advantages and in accordance with the purpose of the invention, as embodied herein, the invention includes a reconfigurable reaction wheel for spacecraft. The reaction wheel includes a reaction wheel housing, a flywheel rotatably disposed in the housing and an electric motor operably coupled to the flywheel. The electric motor includes a plurality of electrical windings. The motor is adapted and configured to operate in a first selectable operating state wherein the windings are arranged in a first electrical configuration, and a second selectable operating state wherein the windings are arranged in a second electrical configuration different from the first electrical configuration.

In accordance with a further aspect of the invention, the electric motor may be further adapted and configured to operate in a third selectable operating state wherein the windings are arranged in a third electrical configuration different from the first and second electrical configurations. It will be appreciated by those of skill in the art that any plural number of operating states having windings arranged in varying electrical configurations (e.g., fourth, fifth, sixth, seventh, eighth, ninth and tenth) may be realized in accordance with the invention.

In accordance with another aspect of the invention, the motor is adapted and configured to generate different amounts of torque in each selectable operating state. For example, if three operating states are provided, the electric motor may be adapted to generate more torque in the third selectable operating state than in the second selectable operating state, and generate more torque in the second selectable operating state than in the first selectable operating state. In order to vary the amount of torque, in accordance with one embodiment of the invention, a plurality of the motor windings are configured into multiple parallel circuits in one of the selectable operating states. In accordance with another embodiment of the invention, the motor windings are configured into multiple serial circuits in at least one of the selectable operating states. In accordance with still another embodiment of the invention, the motor windings are configured into a combination of multiple serial and parallel circuits.

In still further accordance with the invention, the reaction wheel may further include means for selecting an operating state of the motor. In accordance with one embodiment of the invention, the means for selecting an operating state of the motor is adapted and configured to permit selection between operating states of the motor from a remote location. Accordingly, the means for selecting an operating state of the motor may include a plurality of electrical circuits adapted and configured to select an operating state of the motor. For example, the electrical circuits may include electromechanical relays adapted and configured to select an operating state of the motor. By way of further example, the electrical circuits may include solid state electronic switches adapted and configured to select an operating state of the motor. In accordance with another embodiment of the invention, the means for selecting an operating state of the motor may include an electrical panel permitting manual selection of the operating state of the motor. The electrical panel may be mounted in a location that is accessible after the housing of the reaction wheel assembly is sealed. For example, the electrical panel may be mounted proximate an exterior surface of the housing and include a plurality of electrical jumpers adapted and configured to permit manual selection between operating states of the motor.

In accordance with yet a further aspect of the invention, the motor in the reaction wheel may be a brushless direct current motor. If desired, the motor may be adapted and configured to permit changing from the first operating state to the second operating state while the flywheel is rotating with respect to the housing.

The invention also provides a spacecraft. The spacecraft includes a bus and a plurality of reaction wheels mounted in the bus. At least one of the reaction wheels is a reconfigurable reaction wheel as described herein.

In further accordance with the invention, the reconfigurable reaction wheel may further include means for selecting an operating state of the motor as described herein that permits selection of the operating state of the motor from a remote location. The spacecraft also preferably includes a control system for selecting the operating state of the motor including a processor adapted and configured to actuate the means for selecting the operating state of the motor to select the motor's operating state.

In accordance with another aspect of the invention, the control system may further include a machine readable program containing instructions for controlling the processor to control the reconfigurable reaction wheel. The program includes means for instructing the processor to select the operating state of the motor of the reconfigurable reaction wheel, and means for instructing the processor to operate the motor.

In accordance with yet another aspect of the invention, the reconfigurable reaction wheel motor of the spacecraft is adapted and configured to operate in the first selectable operating state when the spacecraft is in an acquisition phase and in the second selectable operating state when the spacecraft is in a targeting phase. In accordance with such an application, the reconfigurable reaction wheel motor preferably has a higher torque constant in the second selectable operating state than in the first selectable operating state.

The invention also provides a method of operating a spacecraft. The method includes providing a spacecraft including a bus and a reconfigurable reaction wheel. The reconfigurable reaction wheel is capable of being operated in a first, relatively low torque, high momentum capable operating state and a second, relatively high torque, low momentum capable operating state. The torque constant of a motor used to drive the reaction wheel is different in the first operating state and the second operating state. The method further includes operating the reaction wheel in the first operating state during a first phase of a mission. The method also includes operating the reaction wheel in the second operating state during a second phase of the mission.

In further accordance with the invention, the first phase of the mission may be an acquisition phase of the spacecraft after being released from a launch vehicle. If desired, the second phase of the mission may include targeting the spacecraft in a desired direction. By way of further example, the second phase of the mission may include deploying an instrument from the spacecraft.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention. Together with the description, the drawings serve to explain the principles of the invention.

### BRIEF DESCRIPTION OF THE DRAWINGS

FIG. 1 is an isometric cutaway view of a first representative embodiment of a reconfigurable reaction wheel made in accordance with the present invention.

FIG. 2 is a cross sectional view of the reconfigurable reaction wheel depicted in FIG. 1.

FIGS. 3(a)-3(c) illustrate exemplary winding configurations of a reconfigurable reaction wheel made in accordance with the present invention.

FIG. 4 is a chart illustrating the varying performance obtainable using the winding configurations illustrated in FIG. 3.

FIG. 5 is a schematic view of an exemplary circuit to facilitate selection of an operating state of a motor for a reaction wheel in accordance with the present invention.

FIG. 6 illustrates an equivalent circuit to the circuit of FIG. 5 configured to operate in a first selectable operating state.

FIG. 7 illustrates an equivalent circuit to the circuit of FIG. 5 configured to operate in a second selectable operating state.

FIG. 8 depicts a cross sectional view of the reconfigurable reaction wheel depicted in FIG. 1 mounted on a bus of a spacecraft.

FIG. 9 illustrates a first representation of a spacecraft utilizing one or more reconfigurable reaction wheels made in accordance with the present invention.

FIG. 10 illustrates a second representation of a spacecraft utilizing one or more reconfigurable reaction wheels made in accordance with the present invention.

### DETAILED DESCRIPTION OF THE PREFERRED EMBODIMENT

Reference will now be made in detail to the present preferred embodiments of the invention, an example of which is illustrated in the accompanying drawings. Methods of constructing and operating systems made in accordance with the invention will be described in conjunction with the detailed description of the system.

The devices and systems presented herein may be used for aligning spacecraft in orbit and/or maintaining such alignments. The present invention is particularly suited for aligning spacecraft during different modes of operation.

In accordance with the invention, a r reconfigurable reaction wheel for spacecraft is provided. The reaction wheel includes a reaction wheel housing, a flywheel rotatably disposed in the housing and an electric motor operably coupled to the flywheel.

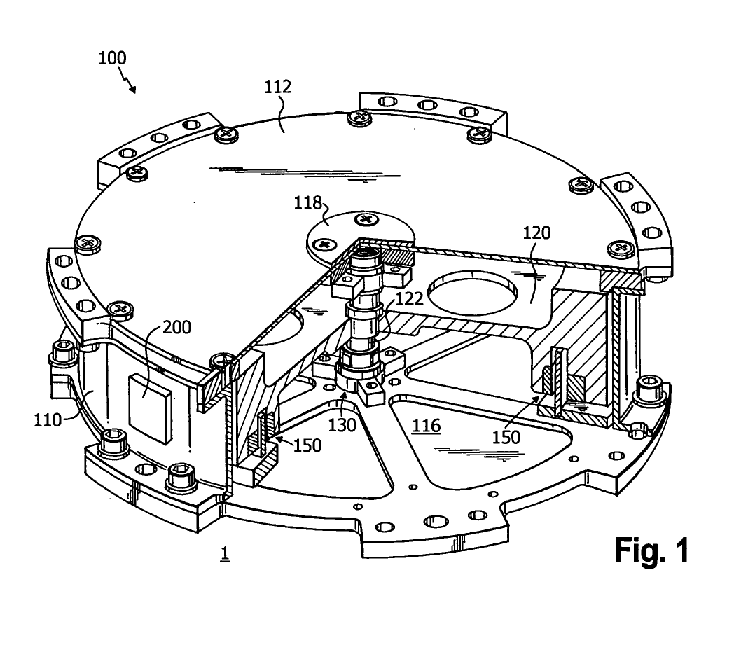

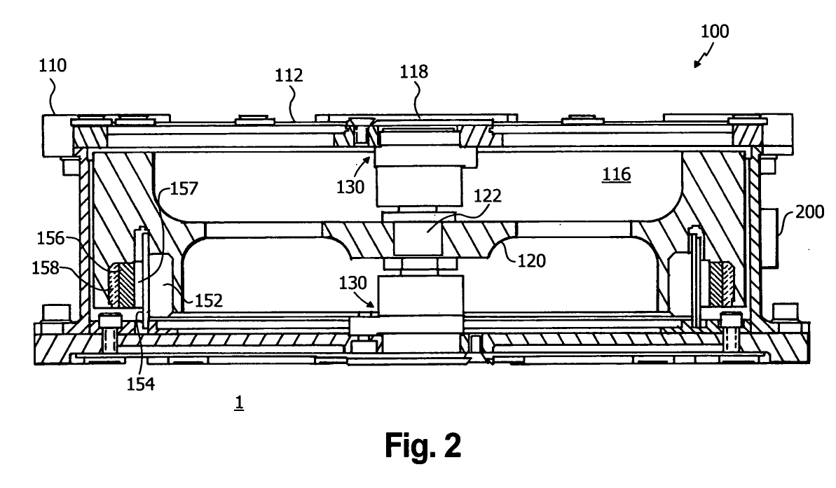

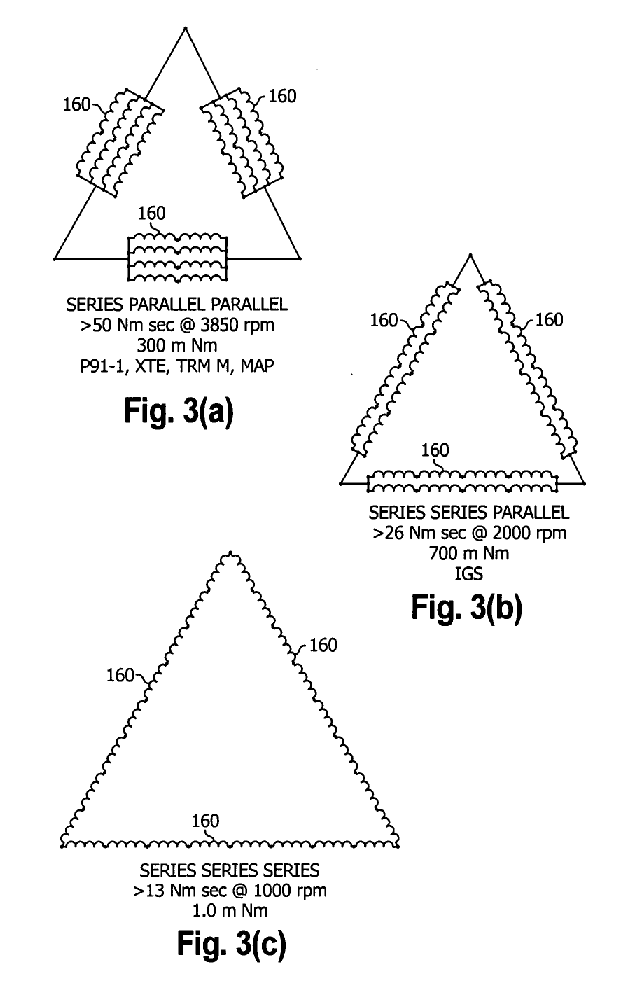

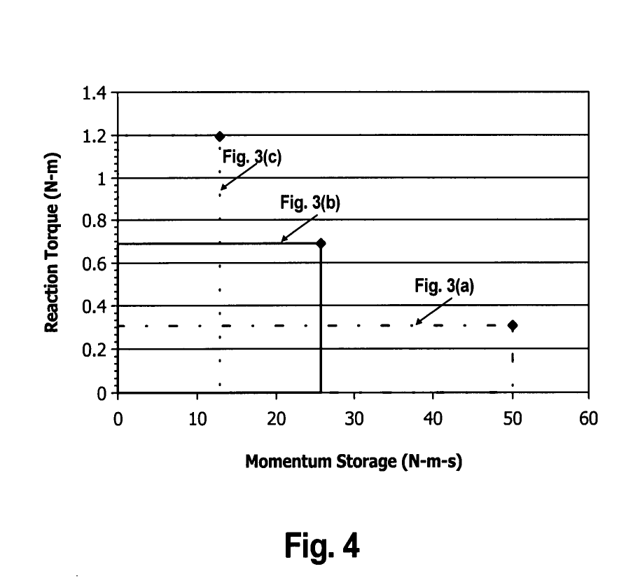

For purpose of explanation and illustration, and not limitation, partial cross-sectional views of an exemplary embodiment of the reconfigurable reaction wheel in accordance with the invention are depicted in FIGS. 1-2 and are designated generally by reference character 100. Other embodiments of a reaction wheel in accordance with the invention, or aspects thereof, are provided in FIGS. 3-10, as will be described.

As depicted in FIGS. 1-2, reaction wheel 100 includes a housing 110 having a generally round shape (when viewed from an end) and access covers 112. It will be appreciated that housing 110 can have any suitable shape and can be made from a variety of materials, including for example aluminum, magnesium or composite materials and can be made in a variety of ways, such as by machining or by stamping metallic sheets or by molding in the event the components of housing 110 are formed from polymeric and/or composite materials. The housing depicted in FIGS. 1-2 is made from aluminum.

It will be appreciated by those of skill in the art that the reaction wheel 100 depicted in the drawings is merely intended to be exemplary, and that the teachings of designing and constructing reconfigurable reaction wheels 100 described herein are applicable to any application requiring a reaction wheel 100 across a variety of operating conditions and torque and momentum requirements.

As is further depicted in FIGS. 1-2, reaction wheel 100 further includes a flywheel 120 mounted on a central shaft 122 adapted and configured to rotate about an axis Z. The flywheel depicted in FIGS. 1-2 is made from aluminum. As depicted, the combination of flywheel 120 and shaft 122 are received by bearing assemblies 130 situated within housing 110.

As further depicted in FIGS. 1-2, a motor 150 is also provided. As depicted, motor 150 is a brushless DC motor having rotor components 152, 156, 157, 158 mounted on the outer peripheral portion of flywheel 120, and a stator portion 154 affixed to housing 110. In the embodiment of FIGS. 1-2, the stator portion includes a plurality of electrical windings 160 which are adapted and configured to drive electric currents that react with permanent magnets 156 of motor 150 mounted on the flywheel 120 to cause the flywheel to rotate.

In prior art reaction wheel devices, the wiring configuration of the windings 160 of motor 150 were fixed during assembly of the reaction wheel 100. However, the windings 160 of reaction wheel 100 made in accordance with the invention can be easily reconfigured after the reaction wheel 100 is completely assembled and the housing 110 is sealed to change the torque constant of the motor to suit particular torque and momentum requirements of applications to which reaction wheel 100 is to be applied.

Exemplary embodiments of winding configurations are presented in FIGS. 3(a)-3(c) using the same number of windings 160, but connecting them in different electrical circuit configurations to modify the torque constant of the wheel. Generally, a brushless DC motor is composed of a plurality of windings 160, wherein the torque generated by the motor is a function of the number of turns in the winding, the number of poles in the motor, the length of the conductors and the magnetic flux density in the motor gap between rotor components 152 and 156. In prior art devices, each motor phase can typically be implemented by a combination of flexible printed circuits with connections of the windings hard wired at the motor terminations. However, the reconfigurable reaction wheel of the invention permits the winding configuration to be reconfigured external to the reaction wheel 100 to change the overall winding pattern and change the resulting motor performance.

For example, the three winding configurations shown in FIGS. 3(a)-3(c) have the same overall number of windings, but are connected differently to produce different operating states of the motor having different torque and momentum capabilities. FIG. 3(a) presents a winding configuration for a three pole motor wherein each pole includes the windings 160 arranged in a first electrical configuration that is parallel on each of the three poles. This first electrical configuration, when implemented on a reaction wheel in a first operating state, is capable of producing a torque of 300 mNm and a momentum storage capacity of greater than 50 Nmsec at 3850 rpm. In accordance with another example, FIG. 3(b) presents the same motor, but wherein the same windings 160 have been reconfigured into a second electrical configuration different from the first electrical configuration wherein the windings are in a combined series/parallel configuration. This second electrical configuration, when operated in this second operating state, is capable of producing a torque of 700 mNm and a momentum storage in excess of 26 Nmsec at 2000 rpm. The winding configuration of the same motor is presented in FIG. 3(c), only in a third configuration different from the first two configurations wherein the windings 160 are arranged in series on each pole. In this third configuration, in this third operating state, the reaction wheel is capable of generating 1.0 Nm of torque and a momentum storage in excess of 13 Nmsec at 1000 rpm.

As can be seen, with each change in the motor windings 160 as indicated in FIG. 3, the motor torque constant k is doubled and the motor back-emf is also doubled. Since speed capability is directly dependent on back-emf, the doubling of torque is accompanied by a reduction in wheel speed by a factor of ½. Thus, the advantage of doubling the torque is at the cost of momentum storage capability, or wheel speed capability. FIG. 4 depicts the progressive increase in reaction torque and decrease in speed capability with each winding configuration depicted in FIG. 3.

It will be appreciated by those of skill in the art that any plural number of operating states having windings arranged in varying electrical configurations (e.g., fourth, fifth, sixth, seventh, eighth, ninth and tenth) may be realized in accordance with the invention by providing a sufficient number of circuits and relays to carry out each operating mode.

In still further accordance with the invention, the reaction wheel may further include means for selecting an operating state of the motor.

For purposes of illustration and not limitation, it is possible, by suitably configuring the motor 150 of reaction wheel 100, to provide a motor design that is able to provide a plurality of operating states that can be selected by a mission planner.

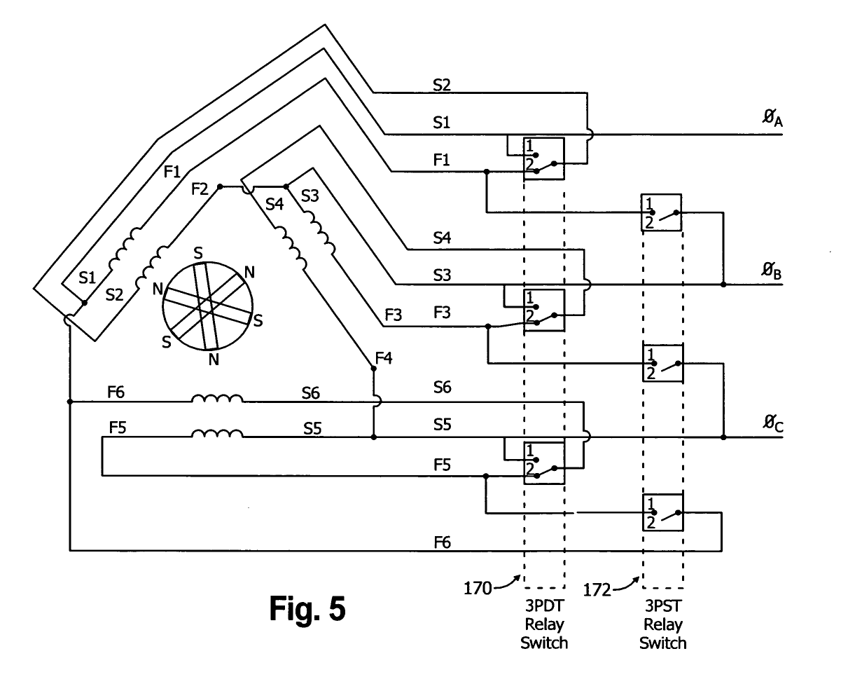

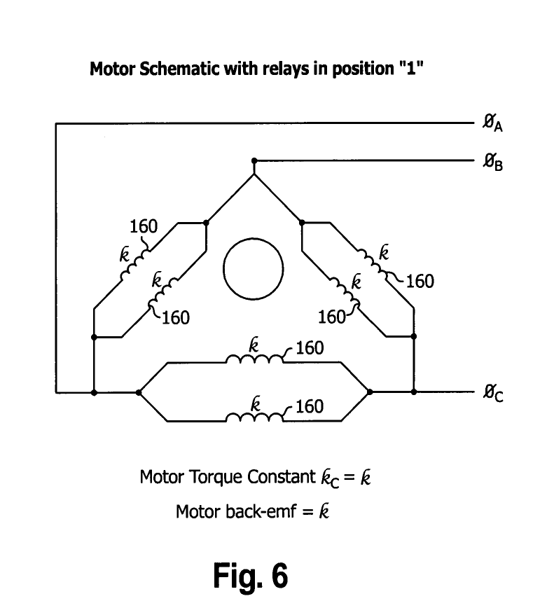

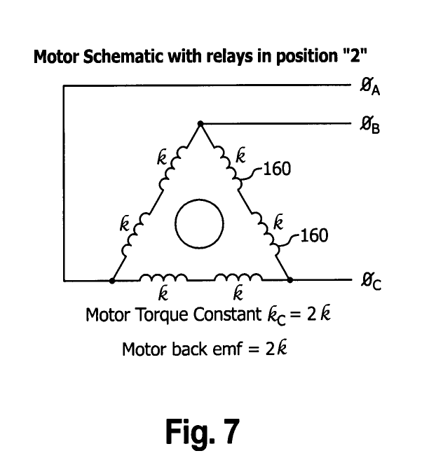

For example, FIG. 5 is a schematic of an example circuit with two windings in each phase of a delta connected brushless DC motor. With the use of two relays 170, 172, (1 3 pole Double Throw and one 3 pole Single Throw) the motor 150 can be changed from a parallel configuration with the relays in position “1”, as shown in FIG. 6, to a series configuration with the relays in position “2”, as shown in FIG. 7. For a hard wired option, the same variation can be performed, for example, with nine pins brought to an external connector of the housing 110 of the reaction wheel. By way of further example, the electrical circuits 170, 172 used to select an operating state of motor 150 may additionally or alternatively include solid state electronic switches adapted and configured to select an operating state of the motor.

In accordance with one embodiment of the invention, the means for selecting an operating state of the motor may be adapted and configured to permit selection between operating states of the motor from a remote location.

Thus, it will be appreciated by those of skill in the art that it is possible to change the motor torque constant k by external command (such as from a ground operations center), or by external hard wired connection (during assembly of a space vehicle). Advantageously, by providing the hard wired connection (e.g., electrical jumper panel 200 depicted in FIG. 2), it is not necessary to break the seal to the interior 116 of reaction wheel 100, which could contaminate the reaction wheel, as reaction wheels 100 are typically assembled in “clean room” environments.

As embodied herein, motor 150 in the reaction wheel 100 is preferably a brushless direct current motor. However, other alternatives are possible, such as induction motors or stepper motors. If desired, the motor 150 may be adapted and configured to permit changing from the first operating state to the second operating state while the flywheel is rotating with respect to the housing.

In further accordance with the invention, a spacecraft is provided. The spacecraft includes a bus and a plurality of reaction wheels mounted in the bus. At least one of the reaction wheels is a reconfigurable reaction wheel as described herein.

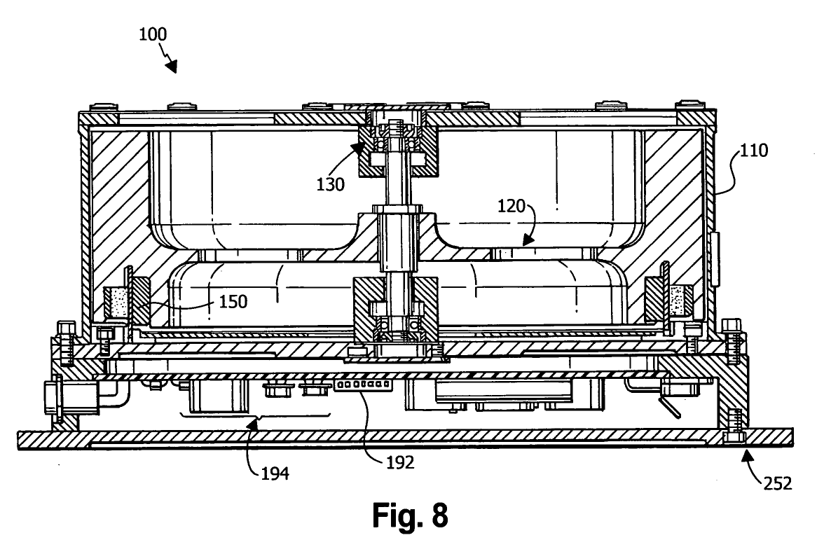

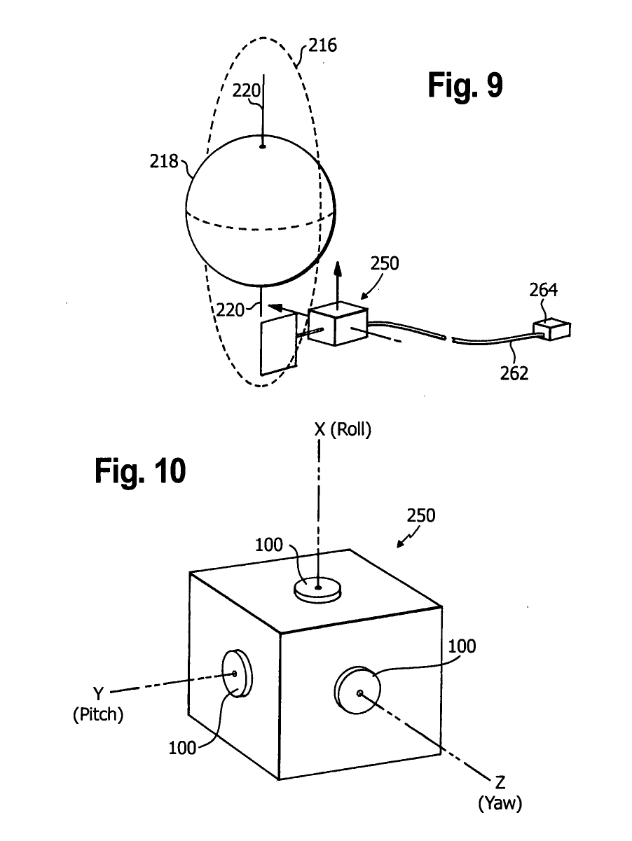

For purposes of illustration and not limitation, as embodied herein and as depicted in FIGS. 8-10, a reaction wheel 100 for use in a spacecraft and spacecraft 250 (e.g., a satellite) are provided, respectively. As depicted in FIG. 10, a reaction wheel 100 is provided in order to provide for adjustment of the attitude of the spacecraft 250 about three orthogonal axes (x, y, z). After release of spacecraft 250 from a launch vehicle, spacecraft enters its acquisition phase wherein it acquires an orbit 216 about a planetary body 218 rotating abut an axis 220 as depicted in FIG. 9. Spacecraft can be provided with any suitable combination of payloads such as a sensor array 264 adaptable to be deployed from the spacecraft along a tether 262 of any suitable length. During the acquisition phase of spacecraft, reaction wheels can be operated in a low-torque, high-momentum operating state in order to compensate for the high kinetic energy imparted on spacecraft 250 as a result of being deployed from the launch vehicle. After completing the acquisition phase, spacecraft 250 can use reaction wheels 100 in a high torque, low momentum operating state to realize relatively rapid aiming of spacecraft 250.

The reconfigurable reaction wheels used in spacecraft 250 are preferably all reaction wheels made in accordance with the invention 100. However, it will be appreciated by those of skill in the art that reaction wheels 100 of the invention may be used alongside reaction wheels of the prior art. The reaction wheel(s) 100 mounted in spacecraft 250 all include a means for selecting an operating state of the motor as described herein. Preferably, the means for selecting an operating state permits selection of the operating state of the motor from a remote location (such as a ground-based control center). However, it will also be appreciated that the reaction wheel 100 of the invention can be configured manually during spacecraft assembly. Being able to configure the operating state of the reaction wheel 100 during final assembly permits multiple reaction wheels 100 to be stored at the spacecraft assembly site that may be modified into various different operating states. This reduces the need for custom designed reaction wheels, and offers the versatility of a reaction wheel 100 that can be configured to operate in different operating states to suit each mission.

If it is desired to change the operating state of reaction wheel 100 after launch of a space vehicle, a control system is provided for selecting the operating state of the motor. For purposes of illustration only, and not limitation, as depicted in FIG. 8, a reaction wheel is depicted mounted on a frame, or bus, 252 of spacecraft 250. An onboard portion of a control system 190 is provided. Control system 190 may also include the portions of control system that are ground-based, such as at a command center. The onboard portion of control system 190 includes, for example, a processor 192 and supporting circuitry 194 adapted and configured to actuate the means for selecting the operating state of the motor 150 to select the motor's operating state. As discussed herein, the means for selecting the motor's operating state (i.e., the means for configuring the motor windings) can include any suitable electrical components (e.g., solid state relays using transistors) and/or electromechanical relays (e.g., 170, 172 depicted in FIG. 5) as desired. The onboard portion of control system 190 further includes means for transmitting and receiving instructions to operate the wheel 100 in one or more selectable operating states. Such means can include any suitable combination of transmitters, receivers, antennae and associated supporting circuitry, as known in the art.

The control system 190 preferably may further include a machine readable program containing instructions for controlling the processor 192 to control the reconfigurable reaction wheel 100. The program includes means for instructing the processor 192 to select the operating state of the motor 150 of the reconfigurable reaction wheel 100, and may include means for instructing the processor 192 to operate the motor 150, as desired.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Block diagrams and other representations of circuitry herein represent conceptual views of illustrative circuitry and software embodying the principles of the invention. Thus the functions of the various elements shown in the Figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. The functions of those various elements may be implemented by, for example, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent to those shown herein.

Similarly, it will be appreciated that the system flows described herein represent various processes which may be substantially represented in computer-readable medium and so executed by a computer or processor, whether or not such computer or processor is explicitly shown. Moreover, the various processes can be understood as representing not only processing and/or other functions but, alternatively, as blocks of program code that carry out such processing or functions.

The following Examples further illustrate the present invention. It will be appreciated that these Examples are intended to merely illustrate, and in no way limit, the invention disclosed herein.

### EXAMPLES

### Example 1

### Single Mission with Multiple Payloads on One Spacecraft

With the ever-increasing cost of spacecraft development, launch and mission operations, it is more common to have multiple payloads on one spacecraft bus. This presents a difficult challenge for the systems engineer since each payload generally has a different set of operating requirements. Parameters related to the reaction wheel such as torque, power, momentum storage and management, and disturbances induced on the payload by a spinning reaction wheel are particularly relevant. Traditionally, the systems engineer gathers together the operating requirements for each payload instrument or experiment on the spacecraft and creates a superset of requirements that encompasses all possible operating conditions. Then, these system level requirements are analyzed and flowed down via hardware specifications to the individual bus sensors and actuators such as reaction wheel assemblies. This approach, by nature, forces mission planners to collect together on one spacecraft a few payloads with similar operating requirements to avoid defining a mission with such widely varying requirements that it cannot be achieved within the scope of prior art reaction wheel technologies. By using a reconfigurable reaction wheel 100 as embodied herein, a change is possible in the current control system strategies that allows mission planners to accommodate a broader range of payload operating requirements using a single spacecraft bus. Several fictitious missions are presented below that are enabled by using the reconfigurable reaction wheel technology described herein that would not be achievable or would be more costly to achieve using current attitude control system strategies.

### Sample Mission 1: Crop Management

Mission Objective: For crop management, a study is under consideration to estimate the water content in the soil in order to determine the proper amount of insecticide to apply to minimize waste and to reduce the run-off of insecticides into local waterways.

Payload: There are two spacecraft instruments required for this study: a microwave imaging camera used to estimate water content in the soil and a highly sensitive detector that can measure insecticide concentrations to determine when spraying has occurred and in what amounts. In conjunction with the space segment, a group of university students will conduct field studies to measure insecticide content in samples taken from local waterways.

Systems Requirements: The microwave imaging camera will be pointed at the numerous fields under study once per day to estimate the water content in the soil. This will require a three-axis stabilized, zero momentum control strategy for the spacecraft using a high torque reaction wheel to slew the spacecraft while maintaining low reaction wheel spin rates during imaging to reduce wheel disturbances at the camera mounting interface. Due to the sensitivity of the insecticide sensor it must be deployed on a tether cable 1000 meters from the spacecraft electrical and magnetic fields. Reaction control thrusters cannot be used for spacecraft spin-up or momentum management because of the potential for sensor contamination. Once per day the insecticide sensor is in use for 20 minutes and once per day the imaging camera is in use for 20 minutes. The remainder of the day is scheduled for recharging the batteries, and deploying and stowing the tether cable. During imaging operations, the spacecraft will perform multiple slews, however, the slews cannot occur with a deployed tether. Thus, the tether cable must be deployed and stowed once per day. Prior to deploying the tether, the spin rate about the spacecraft longitudinal axis is slowly increased using reaction wheels requiring a maximum of 15 N-m-s of momentum storage per wheel. When the desired spin rate is achieved, the tether cable is reeled out, using the momentum stored in the reaction wheels. This momentum exchange continues until the spacecraft returns to zero spin rate and the tether cable is deployed. The reverse operation is performed to stow the tether cable.

Traditional Design Approach: To accomplish this mission using prior art technology, the systems engineer would define a reaction wheel with high torque to perform the spacecraft slewing, large momentum storage capacity to deploy and stow the tether cable, and low wheel imbalance to reduce disturbances at the camera mounting interface. These three requirements would clearly result in a reaction wheel specification with conflicting requirements.

Solution: This mission can be accomplished using a reconfigurable reaction wheel as described herein. In order to deploy and stow the tether cable, each reaction wheel 100 would be switched by remote command to a high momentum, low torque operating state. In order to perform the spacecraft slewing and to minimize the disturbances to the imaging camera, each reaction wheel 100 would be switched to a high torque, low disturbance, low momentum storage operating state.

Summary: In this sample mission, the reconfigurable reaction wheel allows the mission objectives to be met with a single spacecraft, a single set of reaction wheels 100, and a enhanced control system strategy. It will be appreciated by those of skill in the art that many other applications that require a single spacecraft with multiple payloads could benefit by using this reaction wheel technology.

### Example 2

### Single Mission with Changing Orbit

There is a continual need for reductions in the cost of space missions. An ever-increasing number of missions are proposed each year. However, the resources to accomplish even a small fraction of the total desired missions are not available. As technologies emerge that allow resources to be stretched further, there is a need to embrace these technologies whenever possible. It is believed that the reconfigurable reaction wheel technology disclosed herein can reduce the costs of some missions and allow previously hard to realize mission objectives to be more easily attained. The following example illustrates how the flexibility of the reconfigurable reaction wheel 100 enables a single spacecraft to perform in two separate orbits.

### Sample Mission 2: High Precision Mapping

Mission Objective: A high precision mapping mission is being planned to a nearby planet to determine the best locations for a large number of remote weather stations. The spacecraft will spend several months imaging the planet in order to create accurate maps of the planet topography and geology.

Payloads: A spectral imaging camera is the primary payload instrument.

System Requirements: The space mission is divided into two segments: a transfer orbit for interplanetary travel and a low earth orbit for the mapping of the planet surface. The systems engineers determine that during the transfer orbit a momentum bias control strategy will be used. A set of reaction wheels will maintain the large bias momentum providing stability in the presence of the estimated disturbance torques and forces. The systems engineers determine that a three-axis stabilized, zero momentum control strategy will be used during the mapping phase of the mission. During mapping, a set of low torque reaction wheels will be used to pan the camera across the planet surface at a constant rate. It is important to maintain low reaction wheel spin rates during mapping to reduce wheel disturbances at the mounting interface of the camera.

Traditional Design Approach: To accomplish both mission objectives, the systems engineers define two sets of actuators, with each set optimized to perform either the transfer orbit or the mapping phase of the mission. The associated costs of procuring, interfacing and testing two sets of actuators is included in the total program costs.

Solution: Both segments of this mission can be accomplished using a reconfigurable reaction wheel as described herein. To provide a large momentum bias during the transfer orbit, each reaction wheel 100 would be switched by remote command to a high momentum, low torque operating state. In order to perform the mapping phase of the mission and to minimize the disturbances to the imaging camera, each reaction wheel 100 would be switched to a low torque, low disturbance, low momentum storage operating state.

Summary: In this sample mission, the re-configurable Reaction Wheel technology allows both segments of the mission to be met with a single set of reaction wheels 100, electronically re-configured by remote command. The performance-switching capability of the reconfigurable reaction wheel allows a different control system strategy to be used with the same set of reaction wheels 100.

### Example 3

### Multiple Missions with Common Bus Design and Rapidly Deployable Spacecraft

There are some mission applications that require satellite assets to be available at a moment's notice to assist with natural disasters, wars, or other items of safety or national interest. The current strategy is to have multiple satellites in orbit ready to be used when the need arises. It is also common to have spare weather or communications satellites in orbit that are able to replace a failed satellite so that mission objectives can continue with minimal interruption. A large amount of money is expended each year to develop, launch and maintain in orbit this class of quick response satellites and on orbit spares. To this end, a class of satellites is being considered that would be stored in a controlled environment on the ground until they are needed in space. This approach creates different challenges that can also be quite costly but with reduced on-orbit life requirements and reduced orbit maintenance costs, it is expected that the overall program costs can be reduced. It is believed that the reconfigurable reaction wheel technology disclosed herein can be utilized in order to provide flexibility to meet a broad range of mission objectives using a common spacecraft bus as described in the following example.

### Sample Mission 3: Rapid Deployment of Spacecraft

Mission Objectives: In order to be more effective, a government relief agency decides to procure a number of satellites to provide communications and monitoring of conditions after natural disasters. The satellite assets are required for no more than a few months at a time but must be deployable to any part of the world in less than 24 hours.

Payloads: Since both communications and monitoring are necessary, the payload suite will consist of transponders to provide mobile phone service, weather monitoring instrumentation and an imaging camera.

System Requirements: The spacecraft is small enough to be launched from an aircraft platform in order to meet the rapid deployment requirement. Communications and monitoring will be achieved using a spacecraft placed in geosynchronous orbit and imaging will be achieved using a spacecraft placed in low earth orbit. The control system strategy for the geosynchronous spacecraft will be momentum biased using a high speed, low momentum reaction wheel. For the low earth orbit spacecraft, the control system strategy will be three-axis stabilized, zero momentum using high torque, low noise reaction wheels.

Traditional Design Approach: To accomplish both missions, the systems engineer would define two spacecraft each with a different set of instrumentation, bus sensors and actuators. Several of each type of spacecraft would be held in ground storage with one spacecraft of each type being maintained in a warm (powered, tested and monitored) condition for rapid deployment.

Solution: To save costs, the systems engineer would define one spacecraft to accomplish both missions. With this approach, the non-recurring development costs are higher, but the development, testing and maintenance costs would be significantly lower. The reconfigurable reaction wheel 100 disclosed herein can be used to accomplish both the momentum biased and the three-axis stabilized control strategy. The bus and the full suite of payload instrumentation are maintained in warm storage. Upon notification of which mission is to be performed, the payload instruments that will not be necessary to accomplish the mission are quickly removed. Since the reaction wheel 100 can be re-configured electronically by remote command, it is not necessary to switch out or replace the reaction wheels 100 prior to launch. This flexibility reduces the cost of this subsystem while still providing the capability to meet either set of mission objectives. The largest cost savings occurs because the program objectives can be met with half the number of spacecraft being held in ground storage since either mission can be performed with one spacecraft design.

Summary: In this sample mission, the re-configurable Reaction Wheel technology allows the mission objectives to be met with a common bus design, and a single set of electronically configurable reaction wheels 100 to provide two independent control system strategies.

The methods and systems of the present invention, as described above and shown in the drawings, provide for a reaction wheel and spacecraft with superior flexibility that can provide unprecedented flexibility to mission planners. It will be apparent to those skilled in the art that various modifications and variations can be made in the devices and methods of the present invention without departing from the spirit or scope of the invention. Thus, it is intended that the present invention include modifications and variations that are within the scope of the appended claims and their equivalents.

What is claimed is:

1. A reconfigurable reaction wheel for spacecraft, comprising:
a) a reaction wheel housing;
b) a flywheel rotatably disposed in the housing;
c) an electric motor operably coupled to the flywheel, the electric motor having a plurality of electrical windings and being adapted and configured to operate in;
i) a first selectable operating state wherein the windings are arranged in a first electrical configuration; and
ii) a second selectable operating state wherein the windings are arranged in a second electrical configuration different from the first electrical configuration.

2. The reconfigurable reaction wheel of claim 1, wherein the electric motor is further adapted and configured to operate in a third selectable operating state wherein the windings are arranged in a third electrical configuration different from the first and second electrical configurations.

3. The reconfigurable reaction wheel of claim 1, wherein the electric motor is capable of generating more torque in the second selectable operating state than in the first selectable operating state.

4. The reconfigurable reaction wheel of claim 3, wherein a plurality of windings are configured into multiple parallel circuits in at least one of the selectable operating states.

5. The reconfigurable reaction wheel of claim 2, wherein the electric motor is adapted to:
a) generate more torque in the third selectable operating state than in the second selectable operating state; and
b) generate more torque in the second selectable operating state than in the first selectable operating state.

6. The reconfigurable reaction wheel of claim 5, wherein a plurality of windings are configured into multiple serial circuits in at least one of the selectable operating states.

7. The reconfigurable reaction wheel of claim 1, further comprising means for selecting an operating state of the motor.

8. The reconfigurable reaction wheel of claim 7, wherein the means for selecting an operating state of the motor is adapted and configured to permit selection between operating states of the motor from a remote location.

9. The reconfigurable reaction wheel of claim 8, wherein the means for selecting an operating state of the motor includes a plurality of electrical circuits adapted and configured to select an operating state of the motor.

10. The reconfigurable reaction wheel of claim 9, wherein the electrical circuits include electromechanical relays adapted and configured to select an operating state of the motor.

11. The reconfigurable reaction wheel of claim 9, wherein the electrical circuits include solid state electronic switches adapted and configured to select an operating state of the motor.

12. The reconfigurable reaction wheel of claim 8, wherein the means for selecting an operating state of the motor includes an electrical panel permitting manual selection of the operating state of the motor, the electrical panel being mounted in a location that is accessible after the housing of the reaction wheel assembly is sealed.

13. The reconfigurable reaction wheel of claim 12, wherein the electrical panel is mounted proximate an exterior surface of the housing and includes a plurality of electrical jumpers adapted and configured to permit manual selection between operating states of the motor.

14. The reconfigurable reaction wheel of claim 1, wherein the motor is a brushless direct current motor.

15. The reconfigurable reaction wheel of claim 1, wherein the motor is adapted and configured to permit changing from the first operating state to the second operating state while the flywheel is rotating with respect to the housing.

16. A spacecraft comprising:
a) a bus;
b) a plurality of reaction wheels mounted in the bus, at least one of the reaction wheels being a reconfigurable reaction wheel including:
i) a reaction wheel housing;
ii) a flywheel rotatably disposed in the housing;
iii) an electric motor operably coupled to the flywheel, the electric motor having a plurality of electrical windings and being adapted and configured to operate in:
(1) a first selectable operating state wherein the windings are arranged in a first electrical configuration; and
(2) a second selectable operating state wherein the windings are arranged in a second electrical configuration different from the first configuration.

17. The spacecraft of claim 16, wherein the reconfigurable reaction wheel further includes means for selecting an operating state of the motor that permits selection of the operating state of the motor from a remote location.

18. The reconfigurable reaction wheel of claim 17, wherein the means for selecting an operating state of the motor includes at least one of:
a) electromechanical relays adapted and configured to select the operating state of the motor; and
b) solid state electronic switches adapted and configured to select the operating state of the motor.

19. The spacecraft of claim 16, further comprising a control system for selecting the operating state of the motor including a processor adapted and configured to actuate the means for selecting the operating state of the motor to select the motor's operating state.

20. The spacecraft of claim 19, wherein the control system further includes a machine readable program containing instructions for controlling the processor to control the reconfigurable reaction wheel, wherein the program comprises:
a) means for instructing the processor to select the operating state of the motor of the reconfigurable reaction wheel; and
b) means for instructing the processor to operate the motor.

21. The spacecraft of claim 16, wherein the reconfigurable reaction wheel motor of the spacecraft is adapted and configured to operate in the first selectable operating state when the spacecraft is in an acquisition phase.

22. The spacecraft of claim 21, wherein the reconfigurable reaction wheel motor of the spacecraft is adapted and configured to operate in the second selectable operating state when the spacecraft is in a targeting phase.

23. The spacecraft of claim 22, wherein the reconfigurable reaction wheel motor has a higher torque constant in the second selectable operating state than in the first selectable operating state.

24. A method of operating a spacecraft comprising:
a) providing a spacecraft including a bus and a reconfigurable reaction wheel, the reconfigurable reaction wheel being capable of being operated in a first, relatively low torque, high momentum capable operating state and a second, relatively high torque, low momentum capable operating state, wherein the torque constant of a motor used to drive the reaction wheel is different in the first operating state and the second operating state;
b) operating the reaction wheel in the first operating state during a first phase of a mission; and
c) operating the reaction wheel in the second operating state during a second phase of the mission.

25. The method of claim 24, wherein the first phase of the mission is an acquisition phase of the spacecraft after being released from a launch vehicle.

26. The method of claim 24, wherein the second phase of the mission includes targeting the spacecraft in a desired direction.

27. The method of claim 24, wherein the second phase of the mission includes deploying an instrument from the spacecraft.
